(19) United States
(12) Patent Application Publication
(10) Pub. No.: US 2026/0212689 A1
(43) Pub. Date: Jul. 23, 2026

(54) LANE LINE DETECTION METHOD, AUTONOMOUS MOBILE DEVICE, AND STORAGE MEDIUM

(71) Applicants: KUKA Robotics Guangdong Co., Ltd., Foshan (CN); GD Midea Air-Conditioning Equipment Co., Ltd., Foshan (CN); MIDEA GROUP CO., LTD., Foshan (CN)

(72) Inventors: Xiuzhong Wang, Foshan (CN); Ke Huang, Foshan (CN); Wei Xi, Foshan (CN); Jianbin Luo, Foshan (CN)

(21) Appl. No.: 19/571,553

(22) Filed: Mar. 19, 2026

Related U.S. Application Data
(63) Continuation of application No. PCT/CN2023/119740, filed on Sep. 19, 2023.

(51) Int. Cl. G06V 20/56; G05D 1/646; G06T 7/246; G06T 7/269; G06T 7/73; G06V 10/44; G06V 10/56

(52) U.S. Cl. CPC G06V 20/588; G05D 1/646; G06T 7/246; G06T 7/269; G06T 7/74; G06V 10/443; G06V 10/56; G06T 2207/30256

(57) ABSTRACT

Provided are a lane line detection method, an autonomous mobile device, and a storage medium. In the lane line detection method, an original image captured by a camera of the autonomous mobile device is acquired, and an ab-channel-based gradient image is calculated according to the original image. Line segments located on edges of lane lines are extracted from the ab-channel-based gradient image, to obtain multiple original line segments. Collinear line segments among the multiple original line segments are cascaded in an iterative manner, to obtain multiple cascaded line segments. Multiple candidate lane lines are generated from the multiple cascaded line segments. Collinear candidate lane lines of the multiple cascaded line segments are merged to obtain lane lines in the original image.

### CROSS-REFERENCE OF RELATED APPLICATIONS

This application is a continuation of International application PCT/CN2023/119740 filed on Sep. 19, 2023, the entire disclosures of which are incorporated herein by reference.

### TECHNICAL FIELD

The present disclosure relates to the technical field of autonomous mobile devices, and particularly to a lane line detection method, an autonomous mobile device, and a storage medium.

### BACKGROUND

Lane line detection is the core of lane keeping technology. By detecting lane lines, the pose of the vehicle body of an autonomous mobile device may be fed back in real time, so that the autonomous mobile device may timely adjust the movement direction and speed according to the real-time pose, thereby ensuring that the vehicle body keeps within a lane (which is an area between two lane lines) in a stable driving state, or assisting the autonomous mobile device to safely and smoothly change from a starting lane to another lane when the autonomous mobile device changes lanes.

The existing lane line detection technologies include a computer vision method. The computer vision method generally include operations as follows: performing low-level feature extraction on an image acquired by a camera on the autonomous mobile device; performing classification and discrimination on the extracted features; performing curve fitting on features meeting the classification and discrimination, to obtain candidate lane lines; and grouping the candidate lane lines, and removing erroneous lane lines from the candidate lane lines by means of vanishing points, thereby obtaining the final lane lines. This computer vision method has high requirements on the quality of images acquired by the camera, and is usually only applicable to images with a large angle of view and less reflection. In a case where the camera is installed at a low height, the presentation of lane lines in the images decreases at a speed inversely proportional to the square of the distance, and segmented lane lines would be presented in the images of lane lines due to a large amount of reflected light, which results in low robustness and low accuracy of lane line detection. In addition, images with a large angle of view and less reflection require the camera to be installed at a high height, which has high requirements on the height of the autonomous mobile device itself, and it is not suitable for autonomous mobile devices with a low height. It has poor practicability.

That is to say, it is currently applicable to only images with a large angle of view and less reflection. In the case where the camera is installed at a low height, there are problems of low robustness, low accuracy and poor practicability of lane line detection.

### SUMMARY

The embodiments of the present disclosure provide a lane line detection method, an autonomous mobile device, and a storage medium.

In a first aspect, the embodiments of the present disclosure provide a lane line detection method. The method includes: acquiring an original image captured by a camera of an autonomous mobile device, and calculating an ab-channel-based gradient image according to the original image; extracting, from the ab-channel-based gradient image, line segments located on edges of lane lines, as multiple original line segments; obtaining multiple cascaded line segments, by cascading, in an iterative manner, collinear line segments among the multiple original line segments; generating multiple candidate lane lines from the multiple cascaded line segments; and obtain lane lines in the original image by merging collinear candidate lane lines of the multiple cascaded line segments.

In a second aspect, the embodiments of the present disclosure provide an autonomous mobile device including a memory and a processor. The memory stores an application program which, when being called by the processor, causes the method provided in the embodiments of the present disclosure to be implemented.

In a third aspect, the embodiments of the present disclosure provide a computer-readable storage medium storing program codes thereon. The program codes, when being called by a processor, cause the processor to execute the method provided in the embodiments of the present disclosure.

### BRIEF DESCRIPTION OF THE DRAWINGS

In order to more clearly illustrate the technical solutions in the embodiments of the present disclosure, drawings required for the description of the embodiments will be briefly introduced below. Apparently, the drawings described below are only some embodiments of the present disclosure, but not all embodiments. All other embodiments and drawings, obtained by those ordinary skilled in the art based on the embodiments of the present disclosure without any creative efforts, shall fall within the protection scope of the present disclosure.

FIG. 1 is a structural block diagram of an autonomous mobile device as provided in an embodiment of the present disclosure.

FIG. 2 is a schematic flow chart of a lane line detection method as provided in an embodiment of the present disclosure.

FIG. 3 is a schematic flow chart of the lane line detection method as provided in another embodiment of the present disclosure.

FIG. 4 illustrates a grayscale image of an original image as provided in an exemplary embodiment of the present disclosure.

FIG. 5 illustrates an image in L channel of the original image corresponding to the grayscale image of FIG. 4.

FIG. 6 illustrates an image in a color channel of the original image corresponding to the grayscale image of FIG. 4.

FIG. 7 illustrates an image in b color channel of the original image corresponding to the grayscale image of FIG. 4.

FIG. 8 is a diagram schematically illustrating lane lines as provided in an exemplary embodiment of the present disclosure.

FIG. 9 is a diagram schematically illustrating the result obtained after adding extracted original line segments to the original image corresponding to the grayscale image of FIG. 4 as provided in an exemplary embodiment of the present disclosure.

FIG. 10 is a schematic histogram as provided in an exemplary embodiment of the present disclosure.

FIG. 11 is a schematic flow chart of step S130 in FIG. 3 of the present disclosure.

FIG. 12 is a schematic flow chart of step S140 in FIG. 3 of the present disclosure.

FIG. 13 is a schematic diagram illustrating a color verification process as provided in an exemplary embodiment of the present disclosure.

FIG. 14 is a schematic diagram illustrating a color verification process as provided in another exemplary embodiment of the present disclosure.

FIG. 15 is a schematic flow chart of step S150 in FIG. 3 of the present disclosure.

FIG. 16 is a schematic flow chart of a lane line detection method as provided in a further embodiment of the present disclosure.

FIG. 17 is a schematic diagram illustrating a lane keeping process as provided in an exemplary embodiment of the present disclosure.

FIG. 18 is a schematic diagram illustrating the lane keeping process as provided in another exemplary embodiment of the present disclosure.

FIG. 19 is a schematic diagram illustrating the lane keeping process as provided in a further exemplary embodiment of the present disclosure.

FIG. 20 is a schematic diagram illustrating the lane keeping process as provided in yet a further exemplary embodiment of the present disclosure.

FIG. 21 is a structural block diagram of a lane line detection apparatus as provided in an embodiment of the present disclosure.

FIG. 22 is a structural block diagram of an autonomous mobile device as provided in another embodiment of the present disclosure.

### DETAILED DESCRIPTION OF PREFERRED EMBODIMENTS

In order to enable those skilled in the art to better understand the solutions of the present disclosure, the technical solutions in the embodiments of the present disclosure will be clearly and comprehensively described below in conjunction with drawings in the embodiments of the present disclosure.

The lane line detection method provided in the embodiments of the present disclosure may be applied to/implemented by the autonomous mobile device or the lane line detection apparatus provided in the embodiments of the present disclosure. Next, the autonomous mobile device provided in an embodiment of the present disclosure will be introduced.

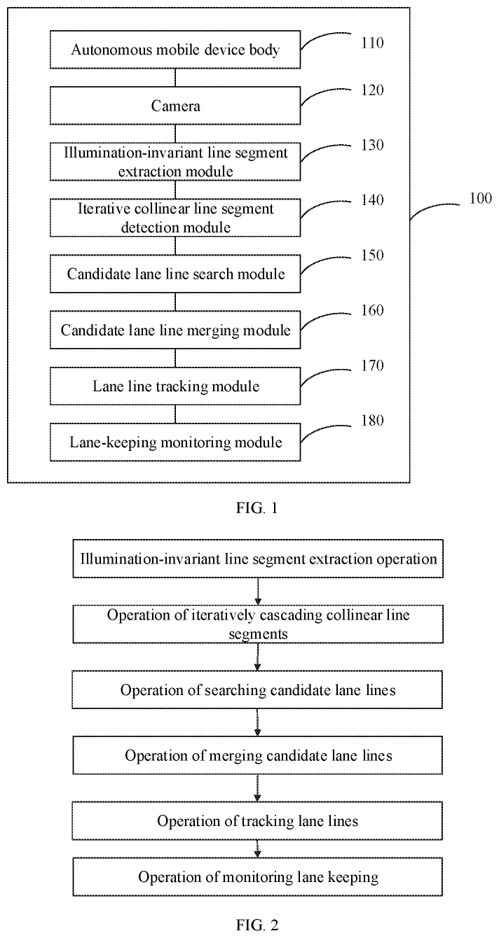

Referring to FIG. 1, a structural block diagram of an autonomous mobile device as provided in an embodiment of the present disclosure is illustrated. The autonomous mobile device 100 may include, but is not limited to, an Autonomous Mobile Robot (AMR for short) or an Automated Guided Vehicle (AGV for short). The autonomous mobile device 100 includes an autonomous mobile device body 110, a camera 120, an illumination-invariant line segment extraction module 130, an iterative collinear line segment detection module 140, a candidate lane line search module 150, a candidate lane line merging module 160, a lane line tracking module 170, and a lane-keeping monitoring module 180.

The camera 120 is installed on the autonomous mobile device body 110. The camera 120 may be a camera installed at a low height and having a small angle of view. Images acquired by the camera 120 usually have a large amount of reflected light and low contrast. For a camera installed at a low height, accurate and reliable lane line detection can be realized according to the lane line detection method provided in the embodiments of the present disclosure, thereby reducing the requirements on the height of the autonomous mobile device body and making the lane line detection method provided in the embodiments of the present disclosure have wide practicability. For example, when the autonomous mobile device 100 is located on the ground, a distance between the camera 120 and the ground is less than a specified height, and an included angle between the orientation of the camera 120 and the ground is less than a specified angle. The specified height and the specified angle may be set according to the actual height of the autonomous mobile device body 110.

Referring to FIG. 2, the autonomous mobile device 100 may sequentially perform an illumination-invariant line segment extraction operation, an operation of iteratively cascading collinear line segments, an operation of searching candidate lane lines, an operation of merging candidate lane lines, an operation of tracking lane lines, and an operation of monitoring lane keeping. For example, for each frame of image acquired by the camera 120 during the movement of the autonomous mobile device 100, the illumination-invariant line segment extraction module 130 may be configured to perform the illumination-invariant line segment extraction operation thereon, specifically, it may be configure to perform line segment extraction on the current frame of image with an illumination-invariant line segment extraction method, to obtain a large number of original line segments of the image. The illumination-invariant line segment extraction method refers to a line segment extraction method that extracts, from a gradient image calculated based on the a color channel and b color channel of the original image, line segments located on the edges of lane lines in the gradient image with an edge detection algorithm, without relying on the brightness of the image. The iterative collinear line segment detection module 140 is configured to perform the operation of iteratively cascading collinear line segments, specifically, it may be configured to iteratively cascade collinear line segments among the large number of original line segments, to obtain multiple cascaded line segments. The candidate lane line search module 150 is configured to perform the operation of searching candidate lane lines, specifically, it may be configured to generate multiple candidate lane lines from the multiple cascaded line segments. The candidate lane line merging module 160 is configured to perform the operation of merging collinear candidate lane lines, specifically, it may be configured to merge multiple collinear candidate lane lines to obtain lane lines of the current frame of image. The lane line tracking module 170 is configured to perform the operation of tracking lane lines, specifically, it may be configured to acquire lane lines of consecutive multiple frames of images that are obtained according to the above operations, and determine a reference lane line based on the lane lines of the consecutive multiple frames of images. The lane-keeping monitoring module 180 is configured to perform the operation of monitoring lane keeping, specifically, it may be configured to calculate a pose of the autonomous mobile device 100 relative to the reference lane line, and send an alarm message to prompt that the autonomous mobile device 100 deviates from a lane when the pose meets an alarm condition. For the working process of the above modules 130-180 not described in detailed here, reference may be made to the relevant parts in the following method embodiments.

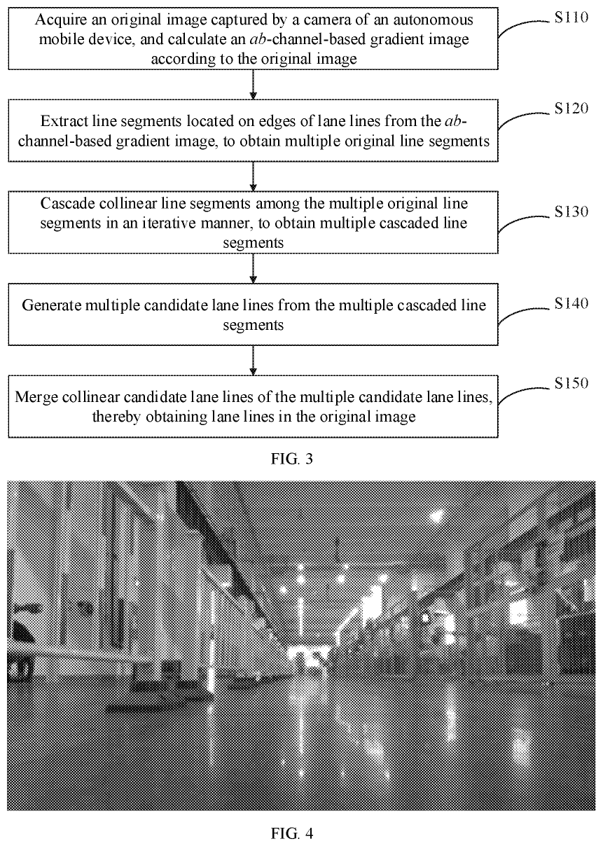

Referring to FIG. 3, a schematic flow chart of a lane line detection method as provided in an embodiment of the present disclosure is illustrated. The lane line detection method may include steps S110 to S150 as follows.

At step S110, an original image captured by a camera of an autonomous mobile device is acquired, and an ab-channel-based gradient image is calculated according to the original image.

The original image acquired by the camera is a true-color image (RGB image), and the colors of the RGB image are obtained by combining three basic colors of Red, Green and Blue. In some embodiments, the camera is installed at a low height and has a small angle of view, and the original image acquired by the camera has a large amount of reflected light and low contrast. In order to handle the situation of large changes in lighting condition and strong reflection, and avoid the influence of brightness on the accuracy of subsequent extraction of original line segments, the illumination-invariant edge detection is needed. In the embodiments of the present disclosure, the original image is converted into a Lab image, and then based on the gradient image obtained based on the a color channel and b color channel of the Lab image, line segments on the edges of lane lines are extracted, which improves the accuracy and robustness of original line segment extraction, because the color difference of the lane line is the most prominent feature. The Lab image is composed of Light (L for short) channel, a color channel and b color channel. When the operation is performed on the image, it may be performed separately on the light channel, the a color channel and the b color channel of the Lab image, and the individual channels do not affect each other, which can improve the robustness of extracting the original line segments. Moreover, the L channel is not considered, the influence of changes in the illumination intensity of the image on the detection result can be avoided, and the accuracy of extracting original line segments can be improved.

Exemplary, an algorithm in the Open Source Computer Vision Library (OpenCV for short) for converting the RGB color space to the XYZ color space may be used to convert the original image from the RGB color space to the XYZ color space; and an algorithm in the OpenCV for converting the XYZ color space to the Lab color space may be used to convert the XYZ color space to the Lab color space, thereby obtaining a Lab image.

After the Lab image is obtained, a DiZenzo operator utilizing graphics processing unit (GPU for short) acceleration may be used to construct the ab-channel-based gradient image based on the a color channel and b color channel of the Lab image. Regarding the DiZenzo operator utilizing GPU acceleration, it means that the existing DiZenzo operator is added to the Compute Unified Device Architecture (CUDA for short) module in OpenCV, and the GPU acceleration is realized for the DiZenzo operator by using the CUDA, to calculate the gradient image based on the a color channel and the b color channel. At present, the DiZenzo operator in OpenCV is usually implemented by a Central Processing Unit (CPU for short); and due to the large amount of calculation for constructing the gradient image, the processing efficiency of the CPU is low. Compared with the existing DiZenzo operator using CPU, the DiZenzo operator utilizing GPU acceleration adopted in the embodiments of the present disclosure can significantly improve the speed of constructing the gradient image, thereby improving the efficiency of the entire lane line detection.

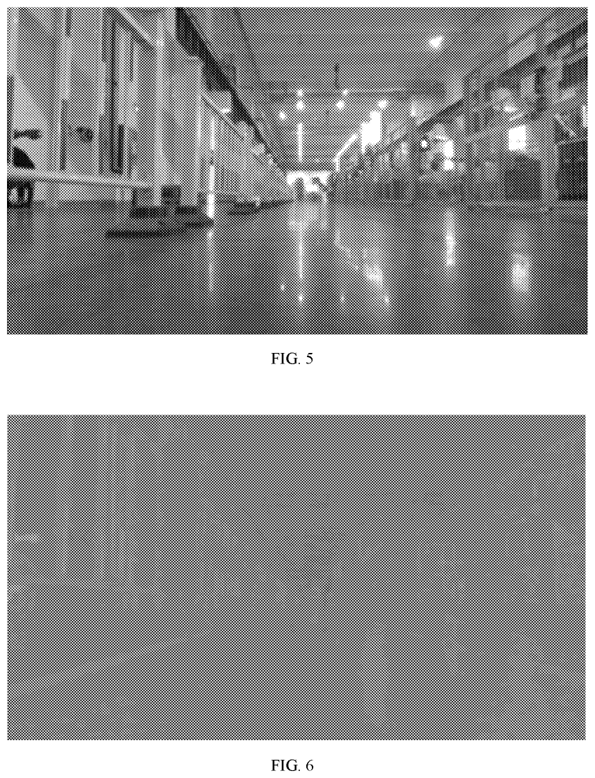

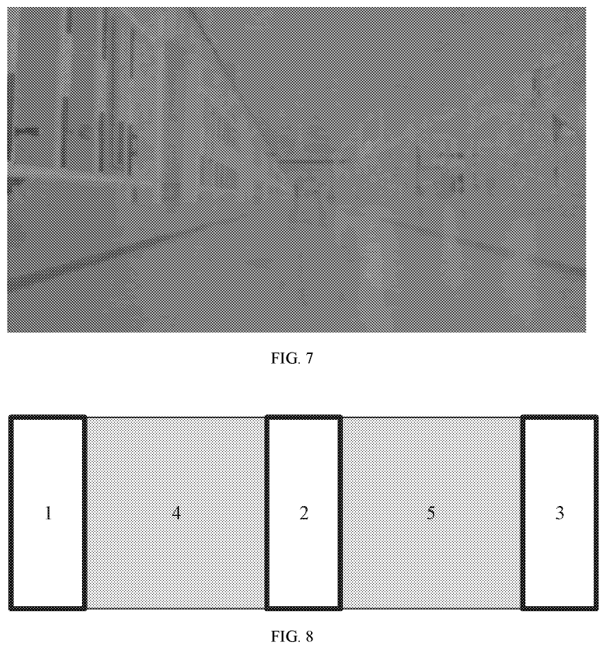

Exemplary, referring to FIG. 4 to FIG. 7, FIG. 4 is a grayscale image of the original image. The original image corresponding to the grayscale image illustrated in FIG. 4 is converted from the RGB color space to the Lab color space to obtain a Lab image. The L channel image in the Lab image is illustrated in FIG. 5, the a color channel image in the Lab image is illustrated in FIG. 6, and the b color channel image in the Lab image is illustrated in FIG. 7.

At step S120, line segments located on edges of lane lines are extracted from the ab-channel-based gradient image, to obtain multiple original line segments.

Referring to FIG. 8, three lane lines 1 to 3 are illustrated. The area between lane line 1 and lane line 2 defines a lane 4, and the area between lane line 2 and lane line 3 defines a lane 5. The bold black parts in lane lines 1 to 3 are the edges of lane lines 1 to 3 respectively.

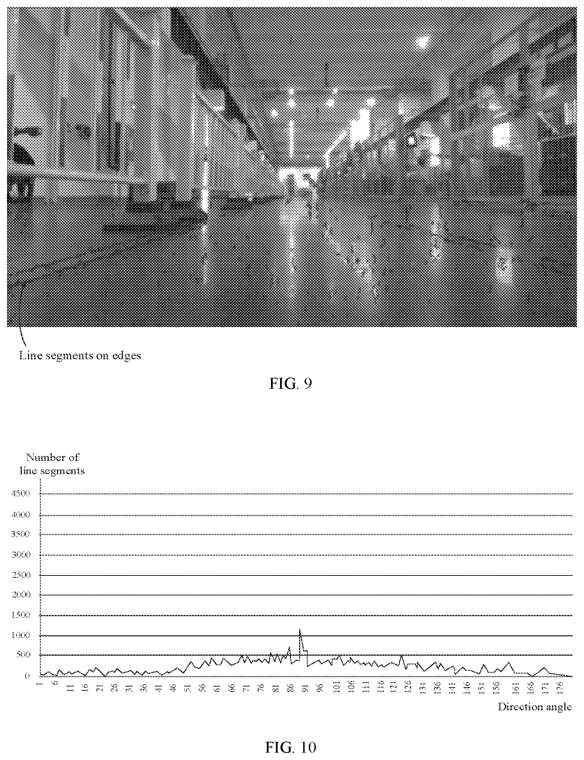

Relevant lane line edge extraction operators may be used to extract line segments located on the edges of lane lines from the ab-channel-based gradient image, thereby obtaining multiple original line segments. The lane line edge extraction operators may include, but are not limited to, Marr-Hildreth operator, Canny operator, Laplacian operator, etc., which are not specifically limited here. For ease of understanding, for example, referring to FIG. 4 and FIG. 9, for the original image corresponding to the grayscale image illustrated in FIG. 4, the operations of steps S110 and S120 are performed thereon to obtain multiple original line segments; and the multiple original line segments are added to the original image, thereby obtaining the original image corresponding to the grayscale image illustrated in FIG. 9, where the line segments indicated by arrows are original line segments.

At step S130, collinear line segments among the multiple original line segments are cascaded in an iterative manner, to obtain multiple cascaded line segments.

For the lane lines in the original image acquired by the camera, the farther a lane line is from the autonomous mobile device, the smaller the width of the lane line; and the closer a lane line is from the autonomous mobile device, the larger the width of the lane line. In order to ensure that the widths of lane lines located at far places and near places are consistent, in the embodiments of the present disclosure, the multiple original line segments are converted to a ground coordinate system, to obtain multiple original line segments in the ground coordinate system; and the included angle between each of the multiple original line segments in the ground coordinate system and the lateral axis of the ground coordinate system may be calculated as the direction angle of each of the multiple original line segments.

A preferred lane line direction may be determined according to the direction angles of the multiple original line segments. Exemplary, all original line segments may be scanned, and a histogram as illustrated in FIG. 10 may be constructed based on the individual direction angles of the multiple original line segments. The lateral axis of the histogram in FIG. 10 represents the direction angles of the original line segments, and the vertical axis represents the number of original line segments. Referring to FIG. 9, after the operation of extracting the original line segments, the multiple original line segments actually also include noise short line segments, such as the noise short line segments in the lane indicated by the dashed line of FIG. 9. Generally, the direction angles of the original line segments on a lane line are consistent with the direction angles of the actual lane line (the included angle between the actual lane line direction and the lateral axis of the ground coordinate system) and the number of such original line segments is large, whereas the direction angles of the noise short line segments are messy and the number of the noise short line segments is small. Therefore, a direction of the original line segments corresponding to the peak value in the histogram (usually the length direction of the original line segment) may be taken as the preferred lane line direction.

After the preferred lane line direction is determined, original line segments having the preferred lane line direction or original line segments with a length greater than a length threshold may be selected, from the multiple original line segments, as preferred line segments, and the preferred flags (for example, bprefered flag) of the preferred line segments may be set to true. The length threshold is used to filter out the above noise short line segments, and the length threshold may be determined according to the actual operation scene of the autonomous mobile device.

The multiple original line segments may be sorted according to their direction angles, to obtain a sequence of original line segments. For example, they may be sorted in order of direction angles from small to large, or in order of direction angles from large to small.

According to the sequence of original line segments, collinear line segments among the multiple original line segments may be sequentially cascaded in an iterative manner, to obtain multiple cascaded line segments. Each iteration involves the cascading of two line segments, the two line segments include a first line segment and a second line segment, the bprefered flag of the first line segment must be true and the first line segment has not been merged. The first line segment involved in the first iteration performed for the first time is a first preferred line segment in the sequence of original line segments. The difference between the direction angles of the second line segment and the first line segment is less than a preset angle, a lateral distance between the second line segment and the first line segment is less than a preset lateral distance error, and a front-rear distance along the line segment direction between the second line segment and the first line segment is less than a preset gap. The preset angle, the preset lateral distance error and the preset gap may all be determined according to the actual requirements on accuracy and the actual operation scene, which are not specifically limited here. In the embodiments of the present disclosure, the purpose of sorting is to facilitate quick finding of the first line segment and the second line segment required for each iteration during iteration, thereby improving the iteration efficiency. The bprefered flag is used to quickly find the first line segment involved in each iteration, which can significantly improve the iteration efficiency. It is notable that the lateral distance in the embodiments of the present disclosure all refers to the distance in the normal direction of the line segment.

Specifically, in the first iteration, the first preferred line segment is obtained from the sequence of original line segments as the first line segment involved in the first iteration, and the bprefered flag of the first line segment must be true and the first line segment has not been merged; and a second line segment that meets an original line segment cascading condition is searched for. Exemplary, a next line segment following the first line segment may be obtained as the second line segment, and it is detected whether the difference between the direction angles of the second line segment and the first line segment is less than the preset angle; if the difference between the direction angles of the second line segment and the first line segment is less than the preset angle, it is detected whether the lateral distance between the second line segment and the first line segment is less than the preset lateral distance error; if the lateral distance between the second line segment and the first line segment is less than the preset lateral distance error, it is detected whether the front-rear distance along the line segment direction between the second line segment and the first line segment is less than the preset gap; and if the front-rear distance between the second line segment and the first line segment along the line segment direction is less than the preset gap, it is determined that the second line segment meeting the original line segment cascading condition is searched out. If any of the above three determinations on the difference of the direction angles, the lateral distance, and the front-rear distance along the line segment direction between the second line segment and the first line segment results is “No”, it is determined that no second line segment is searched out.

If the second line segment is searched out, the first line segment and the second line segment are merged according to the number of original line segments included in each of the first line segment and the second line segment, to obtain a cascaded line segment of this iteration. Exemplary, if the number of original line segments included in the first line segment is greater than or equal to the number of original line segments included in the second line segment, the second line segment is merged with the first line segment with the second line segment located after the first line segment, thereby obtaining the cascaded line segment of this iteration. If the number of original line segments included in the first line segment is less than the number of original line segments included in the second line segment, the first line segment is merged with the second line segment with the first line segment located after the second line segment, thereby obtaining the cascaded line segment of this iteration. By setting the merging order of the first line segment and the second line segment, the efficiency of merging the line segments can be improved. The bprefered flag of the cascaded line segment obtained in this iteration is set to true, and the cascaded line segment obtained in this iteration is used as the first line segment of a next iteration, then it returns to the operation of “searching for a second line segment that meets the original line segment cascading condition” (i.e., the next iteration is entered) until an iteration end condition is met, thereby obtaining multiple cascaded line segments. The iteration end condition is a condition that no new cascaded line segment is generated in the iteration loop.

If the second line segment is not searched out, the bprefered flag of the first line segment is set to false, the first line segment involved in a next iteration is determined from the other preferred line segments according to the sequence of original line segments, and it returns to the operation of “searching for a second line segment that meets the original line segment cascading condition” until the iteration end condition is met, thereby obtaining multiple cascaded line segments. The sorting operation may enable look back traversal which means that, since the first line segment in the iterative cascading might not be in front of the second line segment of the sequence, after the last line segment in the sequence is traversed, it may return to the first line segment in the sequence to continue searching for the second line segment therefor, until the iteration end condition is met.

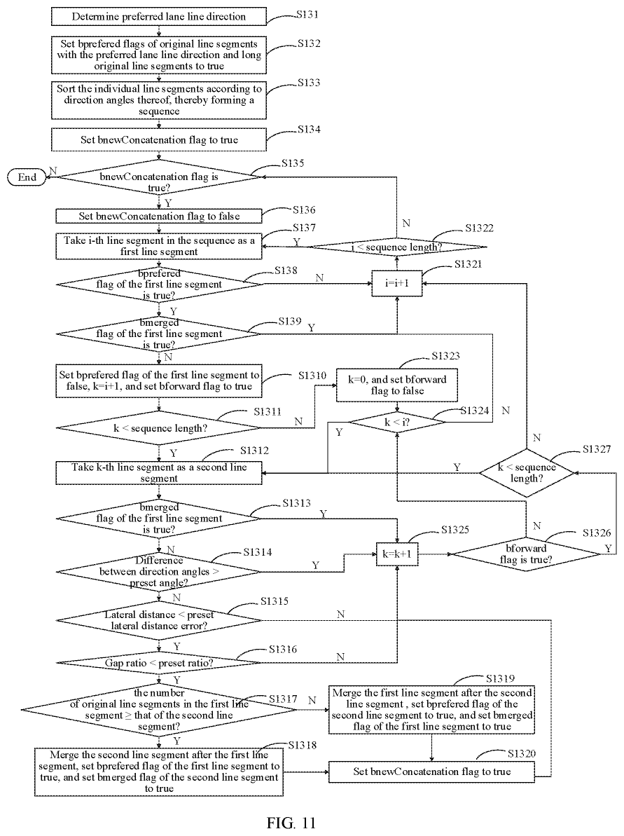

For ease of understanding, an example illustrated in FIG. 11 is provided herein to illustrate the iterative cascading logic of step S130. Step S130 may include steps S131 to S1327 as illustrated in FIG. 11.

At step S131, the preferred lane line direction is determined.

At step S132, the bprefered flags of original line segments with the preferred lane line direction and long original line segments (whose line segment length is greater than a length threshold) are set to true.

At step S133, the individual line segments are sorted according to the direction angles thereof, thereby forming a sequence of original line segments.

At step S134, a new cascaded line segment flag (bnewConcatenation flag) is set to true to initialize the bnewConcatenation flag, which shows that a new cascaded line segment is to be generated, and the first round of iteration is started.

At step S135, it is determined whether the bnewConcatenation flag is true.

If the bnewConcatenation flag is true, it shows that a new cascaded line segment is to be generated, then it proceeds to step S136. If the bnewConcatenation flag is false, it shows that no new cascaded line segment is to be generated, the iteration operation is ended.

At step S136, the bnewConcatenation flag is set to false, and i is set to 0, i.e., i=0.

Specifically, i represents the number in the sequence, the sequence is numbered from 0, and i is an integer greater than or equal to zero. When i=0, it represents a zeroth line segment which actually refers to the first-ranked line segment in the sequence. The total number of line segments included in the sequence (which may also be understood as the sequence length of the sequence) is the maximum value of i plus 1.

In the embodiments of the present disclosure, i, k mentioned below, and j mentioned below are all integers greater than or equal to zero, which are respectively used to acquire the (i+1)-th, (k+1)-th, and (j+1)-th original line segments (or cascaded line segments or candidate lane lines) in the sequence of original line segments (or the sequence of cascaded line segments or the sequence of candidate lane lines). For example, when i is 0, the first-ranked line segment in the sequence is acquired, and the same applies to j and k.

At step S137, the i-th line segment in the sequence is acquired as a first line segment.

At step S138, it is determined whether the preferred flag (bprefered flag) of the first line segment is true.

If the bprefered flag of the first line segment is true, it proceeds to step S139. If the bprefered flag of the first line segment is false, it proceeds to step S1321.

At step S139, it is determined whether the merging flag (bmerged flag) of the first line segment is true.

The bmerged flag is used to represent whether the first line segment has been merged. If the bmerged flag is true, it means that the first line segment has been merged; and if the bmerged flag is false, it means that the first line segment has not been merged. If the bmerged flag of the first line segment is true, it proceeds to step S1321. If the bmerged flag of the first line segment is false, it proceeds to step S1310.

At step S1310, the bprefered flag of the first line segment is set to false, k is set to i+1, and a forward flag (bforward flag) is set to true.

The bforward flag is used to indicate that one line segment has been traversed backward in order of the sequence. k is a number in the sequence, the sequence is numbered from 0, and k is an integer greater than or equal to zero. When k=0, it represents the zeroth line segment which actually refers to the first-ranked line segment in the sequence. The total number of line segments included in the sequence (which may also be understood as the sequence length of the sequence) is the maximum value of k plus 1.

At step S1311, it is determined whether k is less than the sequence length.

If k is less than the sequence length, it proceeds to step S1312. If k is not greater than the sequence length, it proceeds to step 1323.

At step S1312, the k-th line segment is taken as a second line segment.

At step S1313, it is determined whether the bmerged flag of the first line segment is true.

If the bmerged flag of the first line segment is false, it proceeds to step S1314. If the bmerged flag of the first line segment is true, it proceeds to step S1325.

At step S1314, the difference between the direction angles the first line segment and the second line segment is calculated, and it is determined whether the difference between the direction angles is greater than a preset angle.

If the difference between the direction angles is greater than the preset angle, it proceeds to step S1325. If the difference between the direction angles is not greater than the preset angle, it proceeds to step S1315.

At step S1315, the lateral (i.e., normal) distance between the first line segment and the second line segment is calculated, and it is determined whether the lateral distance between the first line segment and the second line segment is less than a preset lateral distance error.

If the lateral distance between the first line segment and the second line segment is less than the preset lateral distance error, it proceeds to step S1316. If the lateral distance between the first line segment and the second line segment is not less than the preset lateral distance error, it proceeds to step S1325.

At step S1316, a gap (i.e., a distance along the line segment direction) between the first line segment and the second line segment in the sequence is calculated, the ratio of the gap to the total length is calculated to obtain a gap ratio, and it is determined whether the gap ratio is less than a preset ratio (the preset ratio may be determined according to the actual operation scene of the autonomous mobile device).

If the gap ratio is less than the preset ratio, it proceeds to step S1317. If the gap ratio is not less than the preset ratio, it proceeds to step S1325.

At step S1317, it is determined whether the number of original line segments included in the first line segment (which may also be understood as the number of merged original line segments included in the first line segment) is greater than or equal to the number of original line segments included in the second line segment (which may also be understood as the number of merged original line segments included in the second line segment).

If the number of original line segments included in the first line segment is greater than or equal to the number of original line segments included in the second line segment, it proceeds to step S1318. If the number of original line segments included in the first line segment is not greater than the number of original line segments included in the second line segment, it proceeds to step S1319.

At step S1318, the second line segment is merged with the first line segment with the second line segment located after the first line segment (that is, the second line segment is merged into the first line segment), the bprefered flag of the merged first line segment is set to true, and the bmerged flag of the second line segment is set to true.

At step S1319, the first line segment is merged with the second line segment with the first line segment located after the second line segment (that is, the first line segment is merged into the second line segment), the bprefered flag of the merged second line segment is set to true, and the bmerged flag of the first line segment is set to true.

At step S1320, the bnewConcatenation flag is set to true. After step S1320 is executed, it proceeds to step S1325.

At step S1321, i is set to i+1, i.e., i=i+1.

At step S1322, it is determined whether i is less than the sequence length.

If i is less than the sequence length, it returns to step S137. If i is not less than the sequence length, it returns to step S135.

At step S1323, k is set to 0, i.e., k=0, and the bforward flag is set to false.

At step S1324, it is determined whether k is less than i. If k is less than i, it return to step S1312. If k is not less than i, it returns to step S1321.

At step S1325, k is set to k+1, i.e., k=k+1.

At step S1326, it is determined whether the bforward flag is true.

If the forward flag is true, it proceeds to step S1327. If the forward flag is false, it returns to step S1324.

At step S1327, it is determined whether k is less than the sequence length.

If k is less than the sequence length, it returns to step S1312. If k is not less than the sequence length, it returns to step S1321.

At step S140, multiple candidate lane lines are generated from the multiple cascaded line segments.

A preset lane line width specification and a preset lane line color specification are acquired. The preset lane line width specification refers to a width specification determined from the standard lane line width specification according to the actual operation scene of the autonomous mobile device, for example, it may be 8-10 centimeters. The preset lane line width specification may include one or more width specifications. The preset lane line color specification refers to a color specification determined from the standard lane line color specification according to the actual operation scene of the autonomous mobile device. The preset lane line color specification may include one or more color specifications, for example, it may be red, yellow, white, and black. Both the preset lane line width specification and the preset lane line color specification belong to prior information preset based on the actual operation scene of the autonomous mobile device. The candidate lane lines generated based on the prior information are closer to the actual lane lines, which can improve the lane line detection accuracy.

Multiple line segment pairs are selected from the multiple cascaded line segments, according to the preset lane line width specification. Exemplary, the included angle between each of the multiple cascaded line segments and the lateral axis of the ground coordinate system may be calculated as the direction angle of each of the multiple cascaded line segments. The multiple cascaded line segments are sorted according to their direction angles, to obtain a sequence of cascaded line segments. The sorting may be performed in order of the direction angles from small to large or from large to small, which is not specifically limited here. According to the sequence of cascaded line segments, multiple line segment pairs are sequentially selected from the multiple cascaded line segments, in which the difference between the direction angles of two line segments included in each line segment pair is less than a preset angle and the lateral distance between the two line segments meets the preset lane line width specification. The lateral distance meeting the preset lane line width specification refers to that the lateral distance meets one of the preset lane line width specifications.

The multiple line segment pairs are selected from the multiple cascaded line segments in an iterative manner, in which each iteration involves matching of two cascaded line segments, and two cascaded line segments successfully matching each other define one line segment pair. Specifically, two cascaded line segments involved in each iteration process are respectively referred to as a first cascaded line segment and a second cascaded line segment, and the preferred flag of the first cascaded line segment must be true. If the first cascaded line segment and the second cascaded line segment are successfully matched, the first cascaded line segment and the second cascaded line segment in the current iteration define one line segment pair.

Exemplary, for each iteration, according to the sequence of cascaded line segments, a first cascaded line segment involved in the current iteration process is determined, and the preferred flag of the first cascaded line segment is true. A second cascaded line segment is searched for in the sequence of cascaded line segments. It is detected whether the first cascaded line segment and the second cascaded line segment meet a matching condition. If the first cascaded line segment and the second cascaded line segment meet the matching condition (that is, a matching second cascaded line segment is found in the sequence of cascaded line segments), the first cascaded line segment and the second cascaded line segment are successfully matched, and the first cascaded line segment and the second cascaded line segment define one line segment pair. If no matching second cascaded line segment is found in the sequence of cascaded line segments, the preferred flag of the first cascaded line segment is set to false, and a first cascaded line segment and a second cascaded line segment of a next iteration are re-determined in the sequence of cascaded line segments, until all line segments in the cascaded line segments are traversed.

The difference between the direction angles of the first cascaded line segment and the second cascaded line segment may be calculated, and it is determined whether the difference between the direction angles of the first cascaded line segment and the second cascaded line segment is less than a preset angle. The lateral distance between the first cascaded line segment and the second cascaded line segment may be calculated, and it is determined whether the lateral distance between the first cascaded line segment and the second cascaded line segment meets the preset lane line width specification. If the difference between the direction angles of the first cascaded line segment and the second cascaded line segment is less than the preset angle, and the lateral distance between the first cascaded line segment and the second cascaded line segment meets (one of) the preset lane line width specification(s), it is determined that the first cascaded line segment and the second cascaded line segment meet the matching condition. If any of the above determinations on the difference of direction angle and lateral distance between the first cascaded line segment and the second cascaded line segment results in “No”, it is determined that the first cascaded line segment and the second cascaded line segment do not meet the matching condition.

A first color verification is performed on the multiple line segment pairs, according to the preset lane line color specification. For each line segment pair in the multiple line segment pairs, the color intensity distributions of two original line segments included in this line segment pair in the a color channel and the b color channel are acquired. If the color intensity distributions of the two original line segments in the a color channel and the b color channel all meet the preset lane line color specification, it is determined that this line segment pair passes the first color verification. If the color intensity distributions of the two original line segments in the a color channel and the b color channel do not meet the preset lane line color specification, it is determined that this line segment pair does not pass the first color verification. The color intensity distribution meeting the preset lane line color specification means that the color intensity distribution meets one of the preset lane line color specifications. Multiple candidate lane lines are generated according to the multiple line segment pairs that pass the first color verification, in which each line segment pair that passes the first color verification corresponds to one candidate lane line. For each line segment pair that passes the first color verification, one candidate lane line may be constructed based on the area between this line segment pair.

Exemplary, after a new line segment pair is generated in each iteration, the first color verification may be performed on the new line segment pair. For example, the color intensity distributions of the two original line segments of the new line segment pair in the a color channel and the b color channel may be acquired; if the color intensity distributions of the two original line segments in the a color channel and the b color channel all meet (one of) the preset lane line color specification(s), it is determined that the new line segment pair passes the first color verification, and one candidate lane line is constructed according to the area between the new line segment pair that passes the first color verification.

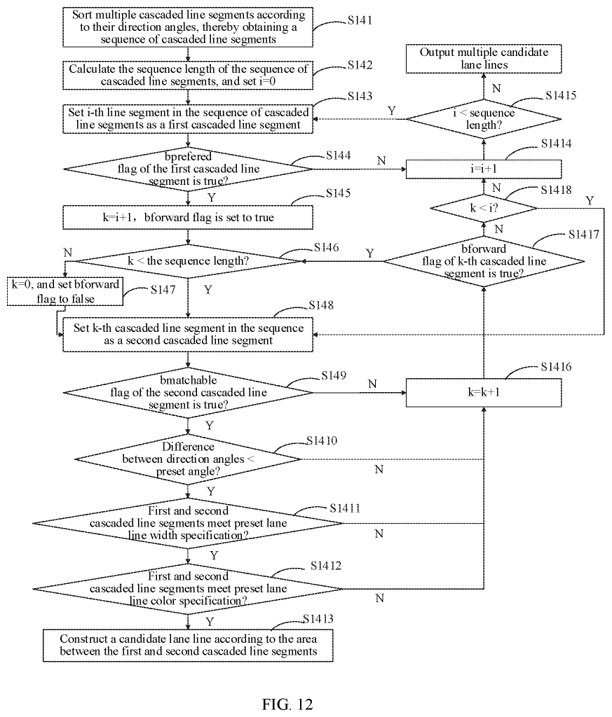

For ease of understanding, an example illustrated in FIG. 12 is provided herein to illustrate the candidate lane line generation logic of step S140. Step S140 may include steps S141 to S1418 illustrated in FIG. 12.

At step S141, the multiple cascaded line segments are sorted according to their direction angles, thereby obtaining a sequence of cascaded line segments.

At step S142, the sequence length of the sequence of cascaded line segments is calculated, and i is set to 0, i.e., i=0.

Specifically, i is a number in the sequence, the sequence is numbered from 0, and i is an integer greater than or equal to zero. When i=0, it represent a zeroth line segment which actually refers to the first-ranked line segment in the sequence. The total number of line segments included in the sequence (which may also be understood as the sequence length of the sequence) is the maximum value of i plus 1.

At step S143, the i-th line segment in the sequence of cascaded line segments is set as a first cascaded line segment.

At step S144, it is determined whether the bprefered flag of the first cascaded line segment is true.

If the bprefered flag of the first cascaded line segment is true, it proceeds to step S145. If the bprefered flag of the first cascaded line segment is false, it proceeds to step S1414.

At step S145, k is set to i+1, i.e., k=i+1, and a bforward flag is set to true.

Specifically, k is a number in the sequence, the sequence is numbered from 0, and k is an integer greater than or equal to zero. When k=0, it represent the zeroth line segment which actually refers to the first-ranked line segment in the sequence. The total number of line segments included in the sequence (which may also be understood as the sequence length of the sequence) is the maximum value of k plus 1.

At step S146, it is determined whether k is less than the sequence length of the sequence of cascaded line segments.

If k is less than the sequence length of the sequence of cascaded line segments, it proceeds to step S148. If k is not less than the sequence length of the sequence of cascaded line segments, it proceeds to step S147.

At step S147, k is set to 0, i.e., k=0, and the bforward flag is set to false.

At step S148, the k-th cascaded line segment in the sequence of cascaded line segments is set as a second cascaded line segment.

At step S149, it is determined whether the matching flag (bmatchable flag) of the second cascaded line segment is true.

The bmatchable flag is used to indicate whether the second cascaded line segment may be used for matching with the first cascaded line segment.

If the bmatchable flag of the second cascaded line segment is true, it is determined that the second cascaded line segment may be used for the subsequent matching operations with the first cascaded line segment, and it proceeds to step S1410. If the bmatchable flag of the second cascaded line segment is false, it is determined that the second cascaded line segment cannot be used for subsequent matching operations with the first cascaded line segment, and it proceeds to step S1416.

At step S1410, the difference between direction angles of the first cascaded line segment and the second cascaded line segment is calculated, and it is determined whether the difference between the direction angles is less than a preset angle.

If the difference between the direction angles of the first cascaded line segment and the second cascaded line segment is less than the preset angle, it proceeds to step S1411. If the difference between the direction angles of the first cascaded line segment and the second cascaded line segment is not less than the preset angle, it proceeds to step S1416.

At step S1411, it is determined whether the first cascaded line segment and the second cascaded line segment meet (one of) the preset lane line width specification(s).

If the first cascaded line segment and the second cascaded line segment meet (one of) the preset lane line width specification(s), it proceeds to step S1412. If the first cascaded line segment and the second cascaded line segment do not meet (one of) the preset lane line width specification(s), it proceeds to step S1416.

At step S1412, a first color verification is performed on the first cascaded line segment and the second cascaded line segment, and it is determined whether the color intensity distributions of the first cascaded line segment and the second cascaded line segment in the a color channel and the b color channel all meet (one of) the preset lane line color specifications.

If the color intensity distributions of the first cascaded line segment and the second cascaded line segment in the a color channel and the b color channel all meet (one of) the preset lane line color specification(s), it proceeds to step S1413. If the color intensity distributions of the first cascaded line segment and the second cascaded line segment in the a color channel and the b color channel do not meet (one of) the preset lane line color specification(s), it proceeds to step S1416.

At step S1413, a candidate lane line is constructed according to the area between the first cascaded line segment and the second cascaded line segment.

At step S1414, i is set to i+1, i.e., i=i+1.

At step S1415, it is determined whether i is less than the sequence length of the sequence of cascaded line segments.

If i is less than the sequence length of the sequence of cascaded line segments, it returns to step S143. If i is not less than the sequence length of the sequence of cascaded line segments, multiple candidate lane lines are output.

At step S1416, k is set to k+1, i.e., k=k+1.

At step S1417, it is determined whether the bforward flag of the k-th cascaded line segment is true.

If the bforward flag of the k-th cascaded line segment is true, it returns to step S146. If the bforward flag of the k-th cascaded line segment is false, it proceeds to step S1418.

At step S1418, it is determined whether k is less than i. If k is less than i, it returns to step S148. If k is not less than i, it returns to step S1414.

At step S150, collinear candidate lane lines of the multiple candidate lane lines are merged, thereby obtaining lane lines in the original image.

Collinear candidate lane lines of the multiple candidate lane lines are merged to obtain multiple long lane lines, where a length of each long lane lines is longer than a length threshold. Collinear candidate lane lines are cascaded to form long lane lines, which can avoid the interference of short lane lines, thereby improving the accuracy of lane line detection. The short lane lines are caused by residual paint of outdated lane lines, or the short lane lines are meaningless for lane keeping. For example, the included angle between each of the multiple candidate lane lines and the lateral axis of the ground coordinate system may be calculated as the direction angle of each of the multiple candidate lane lines; the multiple candidate lane lines are sorted according to their respective direction angles, thereby obtaining a sequence of candidate lane lines; collinear candidate lane lines among the multiple candidate lane lines are sequentially merged according to the sequence of candidate lane lines, thereby obtaining multiple long lane lines.

A second color verification is performed on the multiple long lane lines, and the long lane lines that pass the second color verification are the lane lines in the original image. For example, for each long lane line in the multiple long lane lines, at least one pair of original line segments is found from this long lane line; for each pair of original line segments, the color intensity distributions of an area between the two original line segments in the a color channel and the b color channel are acquired; if the color intensity distributions meet (one of) the preset lane line color specification(s), it is determined that the current long lane line passes the second color verification, and the lane line that passes the second color verification is taken as the lane line in the original image.

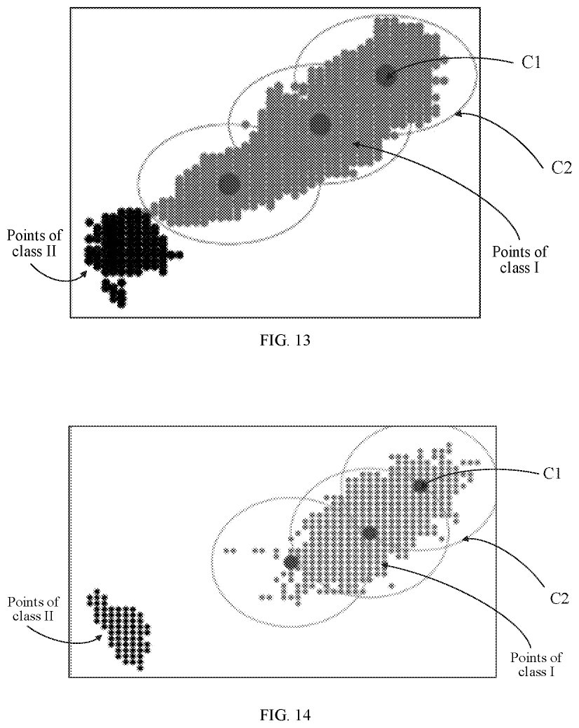

Exemplary, to visualize the second color verification process, referring to FIG. 13 and FIG. 14, the original image involved in FIG. 13 is acquired by a D435 camera, and the original image involved in FIG. 14 is acquired by a Bosheng camera. An open-source image labeling tool may be used to create a bounding box within which pixels of candidate lane lines in multiple frames of original images (points of class I as illustrated in FIG. 13 and FIG. 14) are included, and background pixels (points of class II as illustrated in FIG. 13 and FIG. 14) are also included. For the colors of the pixels of the candidate lane lines, the K-means clustering algorithm is used to cluster the colors of the pixels of each candidate lane line. As illustrated in FIG. 13 and FIG. 14, the small circle C1 represents the clustering center, and the large circle C2 represents the clustering range for each clustering center. C1 and C2 may be determined according to user requirements. After the clustering, the color specification corresponding to each clustering range may be obtained. For each candidate lane line, it may be detected whether the color of each pixel in this candidate lane line is the same as the color specification corresponding to the clustering range where this candidate lane line is located. If they are the same, it is determined that the pixel verification is successful; and if they are not the same, it is determined that the pixel verification fails. The number of detected pixels (m) and the number of successfully verified pixels (n) are calculated. If the number of detected pixels is greater than a preset pixel number threshold (N, for example, N=10) and the ratio of the number of successfully verified pixels (n) to the number of detected pixels (m) is greater than a preset probability, it is determined that the current candidate lane line passes the second color verification. If the condition “the number of detected pixels is greater than the preset pixel number threshold (N, for example, N=10) and the ratio of the number of successfully verified pixels (n) to the number of detected pixels (m) is greater than the preset probability” is still not met after all pixels in the current candidate lane line are traversed, it is determined that the current candidate lane line does not pass the second color verification.

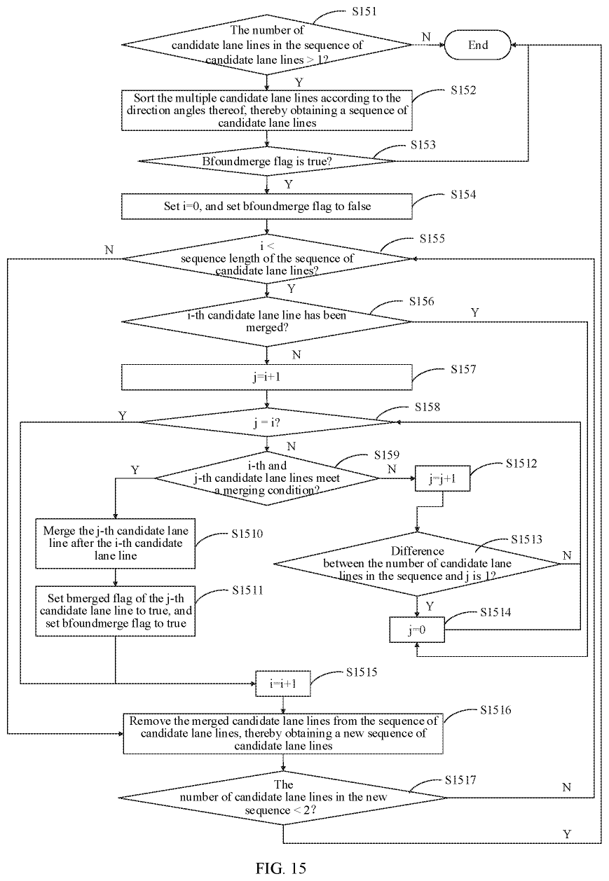

Exemplary, the merging of collinear candidate lane lines and the second color verification process may be performed in an iterative manner. Referring to FIG. 15, step S150 may include step S151 to step S1517.

At step S151, it is determined whether the number of candidate lane lines in the sequence of candidate lane lines is greater than 1.

If the number of multiple candidate lane lines is greater than 1, it proceeds to step S152. If the number of multiple candidate lane lines is not greater than 1, the iteration is ended.

At step S152, the multiple candidate lane lines are sorted according to the direction angles of the multiple candidate lane lines, thereby obtaining a sequence of candidate lane lines.

At step S153, it is determined whether a candidate merging flag (bfoundmerge flag) is true.

If the bfoundmerge flag is true, it shows that a new candidate lane line merging operation is to be performed, and it proceeds to step S154. If the bfoundmerge flag is false, it shows that no new candidate lane line merging operation is to be performed, and the iteration is ended.

At step S154, i is set to 0, i.e., i=0, and the bfoundmerge flag is set to false.

Specifically, i is an integer equal to or greater than zero, which is used to acquire the (i+1)-th ranked candidate lane line in the sequence of candidate lane lines.

At step S155, it is determined whether i is less than the sequence length of the sequence of candidate lane lines.

If i is less than the sequence length of the sequence of candidate lane lines, it proceeds to step S156. If i is not less than the sequence length of the sequence of candidate lane lines, it proceeds to step S1516.

At step S156, it is determined whether the i-th candidate lane line has been merged.

If the i-th candidate lane line has been merged, it proceeds to step S1514. If the i-th candidate lane line has not been merged, it proceeds to step S157.

At step S157, j is set to i+1, i.e., j=i+1.

Specifically, j is an integer equal to or greater than zero, which is used to acquire the (i+1)-th candidate lane line in the sequence of candidate lane lines.

At step S158, it is determined whether j is equal to i.

If j is equal to i, it proceeds to step S1515. If j is not equal to i, it proceeds to step S159.

At step S159, it is determined whether the i-th candidate lane line and the j-th candidate lane line meet a merging condition.

If the i-th candidate lane line and the j-th candidate lane line meet the merging condition, it proceeds to step S1510. If the i-th candidate lane line and the j-th candidate lane line do not meet the merging condition, it proceeds to step S1512.

At step S1510, the j-th candidate lane line is merged with the i-th candidate lane line with the j-th candidate lane line located after the i-th candidate lane line.

In the embodiments of the present disclosure, the setting of the merging order of candidate lane lines can improve the iteration efficiency.

At step S1511, the bmerged flag of the j-th candidate lane line is set to true, and the bfoundmerge flag is set to true. After step S1511 is executed, it proceeds to step S1515.

At step S1512, j is set to j+1, i.e., j=j+1.

At step S1513, it is determined whether the difference between the number of candidate lane lines in the sequence of candidate lane lines and j is 1.

If the difference between the number of candidate lane lines in the sequence of candidate lane lines and j is 1, it proceeds to step S1514. If the difference between the number of candidate lane lines in the sequence of candidate lane lines and j is not 1, it returns to step S158.

At step S1514, j is set to 0, i.e., j=0.

Specifically, j is an integer equal to or greater than zero, which is used to acquire the (j+1)-th ranked candidate lane line in the sequence of candidate lane lines. After step S1514 is executed, it returns to step S158.

At step S1515, i is set to i+1, i.e., i=i+1.

At step S1516, the merged candidate lane lines are removed from the sequence of candidate lane lines, thereby obtaining a new sequence of candidate lane lines.

At step S1517, it is determined whether the number of candidate lane lines in the new sequence of candidate lane lines is less than 2.

If the number of candidate lane lines in the new sequence of candidate lane lines is less than 2, the iteration is ended. If the number of candidate lane lines in the new sequence of candidate lane lines is not less than 2, it returns to step S155.

In some embodiments, considering that some lane lines in the actual operation scene have patterns, pattern verification may also be performed on the lane line that passes the second color verification, to detect whether the pattern on the lane line that passes the second color verification meets (one of) the preset pattern specification(s), and the lane line that meets the preset pattern specifications is taken as the lane line in the original image. The preset pattern specification(s) is also prior information that may be determined according to the actual operation scene of the autonomous mobile device.

In the lane line detection method provided in the embodiments of the present disclosure, by extracting line segments on the edges of lane lines from the gradient image calculated based on the a color channel and b color channel of the image acquired by the camera, and detecting the lane lines in the original image according to the original line segments, illumination-invariant edge detection on images can be enabled. For challenging images with a large amount of reflected light and low contrast, the lane line detection method can extract relatively accurate original line segments, thereby improving the accuracy and robustness of lane line detection. In addition, because the lane line detection method has low requirements on the quality of images, it enables accurate and reliable lane line detection with a camera installed at a low height, thereby reducing the requirements on the height of the autonomous mobile device itself and having wide practicability. In addition, since the actual operation scene of the autonomous mobile device is usually a specific scene, unlike a car that drives in an uncertain scene, it is more convenient to obtain prior information of the actual operation scene of the autonomous mobile device, such as the preset lane line width specification, the preset lane line color specification, and the preset lane line pattern specification, so that the lane line detection method provided in the embodiments of the present disclosure can fully utilize the prior information to improve the performance of lane line detection, and improve the accuracy of lane line detection.

It is notable that, although the embodiments of the present disclosure mentions only the width specification, color specification and pattern specification of lane lines, if there are other specifications for lane lines in the actual operation scene, such as lane line mode specification or lane line background color specification, verification in terms of other specifications for lane lines may be added according to actual needs to improve the accuracy of lane line detection.

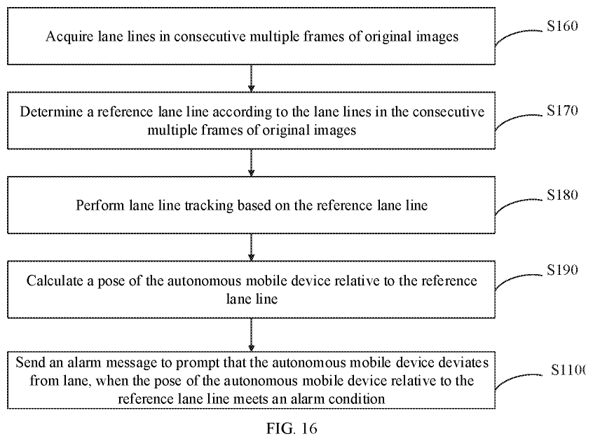

In order to keep the vehicle body within the lane (i.e., between two lane lines) in a stable driving state, or to help realize a safe and smooth transition from the starting lane to the target lane when changing lanes, in some embodiments, referring to FIG. 16, after step S150, the lane line detection method provided in the embodiments of the present disclosure further includes step S160 to step S1110 for lane line tracking.

At step S160, lane lines in consecutive multiple frames of original images are acquired.

During the movement of the autonomous mobile device, whenever the autonomous mobile device acquires the current frame of original image output by the camera, it detects the lane lines in the current frame of original image according to steps S110 to step S150 mentioned above, and thus it can obtain lane lines in consecutive original images. When consecutive multiple frames of original images are acquired, a reference lane line may be determined according to the multiple frames of original images, and lane line tracking may be started according to the reference lane line. The number of the multiple frames of original images may be set according to the actual operation scene and the actual autonomous mobile device, which is not specifically limited here.

At step S170, a reference lane line is determined according to the lane lines in the consecutive multiple frames of original images.

A reference candidate lane line may be determined from the lane lines in the multiple frames of original images. Exemplary, for each lane line among the lane lines in the consecutive frames of original images, the length of this lane line may be calculated; if the length of this lane line is greater than a preset length, this lane line is taken as a reference candidate lane line. The preset length may be determined according to the actual operating scenario of the autonomous mobile device, and it is not specifically limited herein.

If one or more reference candidate lane lines are obtained, it may be detected whether the one or more reference candidate lane lines are detected in all of the multiple frames of original images. Each reference candidate lane line that is detected in all of the multiple frames of original images is selected from the one or more reference candidate lane lines, the distance between each selected reference candidate lane line and the autonomous mobile device is calculated, and one of such selected reference candidate lane line that is closest to the autonomous mobile device is determined as the reference lane line.

If the one or more reference candidate lane lines are not obtained, or if there is no reference candidate lane line detected in all of the multiple frames of original images, it returns to perform step S110 to step S170, until one or more reference candidate lane lines are obtained.

By determining, from the lane lines in consecutive multiple frames of original images, as the reference lane line a lane line whose length is greater than the preset length, which is closest to the autonomous mobile device, and which is detected in all the consecutive multiple ab-channel-based gradient images, it is possible to select a lane line which is relatively long, close to the autonomous mobile device, and within a relatively stable camera field of view as the reference lane line, thereby facilitating lane line tracking.

At step S180, lane line tracking is performed based on the reference lane line.

During the movement of the autonomous mobile device, the lane lines in the current frame of original image are obtained. For each lane line of the lane lines in the current frame of original image, it is detected whether the distance between this lane line and the reference lane line meets a position requirement, where the position requirement may include that the lateral distance between this lane line and the reference lane line is 0 (in this case, this lane line is collinear with the reference lane line); it is detected whether the width of this lane line is the same as the width of the reference lane line; it is detected whether the color intensity distributions of pixels within this lane line in the a color channel and b color channel meet the preset lane line color specification. If the distance between this lane line and the reference lane line meets the position requirement, the width of this lane line is the same as that of the reference lane line, and the color intensity distributions of pixels within this lane line in the a color channel and b color channel meet (one of) the preset lane line color specification(s), this lane line is determined to match the reference lane line.

If there is a lane line matching the reference lane line among the lane lines in the current frame of the original image, the lane line matching the reference lane line is used as the new reference lane line to update the reference lane line. If there is no lane line matching the reference lane line among the lane lines in the current frame of the original image, the reference lane line is kept unchanged and not updated.

If the updating of the reference lane line is failed for a long time after the last updating thereof (for example, the time interval from the last updating to the current time is greater than a preset duration, where the preset duration may be determined according to the actual operating scenario of the autonomous mobile device, such as 5 seconds), or if the autonomous mobile device undergoes a large movement (for example, the autonomous mobile device crosses lanes, or the autonomous mobile device suddenly accelerates rapidly, resulting in failure to find a lane line matching the reference lane line), the reference lane line will become invalid. Then, it needs to re-determine the reference lane line according to steps S110 to S170 with the reference lane line initialized, and continue the lane line tracking based on the initialized reference lane line.

At step S190, a pose of the autonomous mobile device relative to the reference lane line is calculated.

A lane line coordinate system is constructed based on the reference lane line. A camera coordinate system and a vehicle body coordinate system of the autonomous mobile device are acquired. A transformation matrix between the vehicle body coordinate system and the lane line coordinate system is calculated, according to the lane line coordinate system, the vehicle body coordinate system, and the camera coordinate system. The pose of the autonomous mobile device relative to the reference lane line is calculated according to the transformation matrix. The lane line coordinate system may be constructed based on a center line of the reference lane line and the perpendicular bisector of the center line. The origin of the lane line coordinate system is the center of the reference lane line. The vehicle body coordinate system takes the center of the rear axle of the autonomous mobile device as the origin, takes the heading direction of the autonomous mobile device as the x-direction, and takes the left side of the autonomous mobile device as the y-direction.

Exemplary, in the camera coordinate system x-y-z, the center line of the reference lane line is expressed by an equation as follows:

$$x sin θ - z cos θ + c = 0 , θ ∈ [ - π / 2 , π / 2 )$$

where x represents the coordinate of the center line of the reference lane line in the x-direction, z represents the coordinate of the center line of the reference lane line in the z-direction, θ represents the included angle between the center line of the reference lane line and the x-direction, and c represents the distance from the camera to the origin of the lane line coordinate system.

Let the lane line coordinate system be x′-O′-y′, the coordinates of the camera in the camera coordinate system be (x_{c}, z_{c}, 1), the pose of the camera in the lane line coordinate system be (tₓ, 0, α), and the coordinates of the reference lane line in the lane line coordinate system be (xₗ, yₗ, 1), then the transformation matrix between the lane line coordinate system and the camera coordinate system is:

$$[ \begin{matrix}x l \\ y l \\ 1\end{matrix} ] = [ \begin{matrix}cos α & sin α & {t}_{x} \\ sin α & cos α & 0 \\ 0 & 0 & 1\end{matrix} ] [ \begin{matrix}{x}_{c} \\ {z}_{c} \\ 1\end{matrix} ] α ∈ [ - \frac{π}{2} , \frac{π}{2} )$$

It may be derived that:

$$0 = {x}_{c} cos α - {z}_{c} sin α + {t}_{x}$$

$$0 = {x}_{c} sin θ - {z}_{c} cos θ + c .$$

$$For any {z}_{c} , {t}_{x} sin θ - c cos α + {z}_{c} cos ( θ + α ) = 0.$$

$$It may be derived that θ + α = \pm \frac{π}{2} .$$

$$If θ > 0 , then α = \frac{π}{2} - θ , {t}_{x} = c .$$

$$If θ \leq 0 , then α = - \frac{π}{2} - θ , {t}_{x} = - c .$$

Let the reference pose of the camera coordinate system relative to the autonomous mobile device be (x_{b}, y_{b}, β_{b}), then:

$$\begin{matrix}{T}_{L b} = {T}_{L c} {T}_{b c}^{- 1} \\ = {[ \begin{matrix}cos α & sin α & {t}_{x} \\ sin α & cos α & 0 \\ 0 & 0 & 1\end{matrix} ] [ \begin{matrix}cos {β}_{b} & - sin {β}_{b} & {x}_{b} \\ sin {β}_{b} & cos {β}_{b} & {y}_{b} \\ 0 & 0 & 1\end{matrix} ]}^{- 1} \\ = [ \begin{matrix}cos α & sin α & {t}_{x} \\ sin α & cos α & 0 \\ 0 & 0 & 1\end{matrix} ] [ \begin{matrix}cos {β}_{b} & sin {β}_{b} & - {x}_{b} cos {β}_{b} - {y}_{b} sin {β}_{b} \\ - sin {β}_{b} & cos {β}_{b} & {x}_{b} sin {β}_{b} - {y}_{b} cos {β}_{b} \\ 0 & 0 & 1\end{matrix} ] \\ = [ \begin{matrix}cos ( α - {β}_{b} ) & - sin ( α - {β}_{b} ) & {t}_{x} - {x}_{b} cos ( α - {β}_{b} ) + {y}_{b} sin ( α - {β}_{b} ) \\ sin ( α - {β}_{b} ) & cos ( α - {β}_{b} ) & - {x}_{b} sin ( α - {β}_{b} ) - {y}_{b} cos ( {α}_{β} - {β}_{b} ) \\ 0 & 0 & 1\end{matrix} ]\end{matrix}$$

where L represents the lane line coordinate system, b represents the vehicle body coordinate system, c represents the camera coordinate system, T_{Lb} represents the transformation matrix from the lane line coordinate system to the vehicle body coordinate system, T_{Lc} represents the transformation matrix from the lane line coordinate system to the camera coordinate system, and T_{bc}⁻¹ represents the inverse matrix of the transformation matrix from the vehicle body coordinate system to the camera coordinate system, i.e., a transformation matrix from the camera coordinate system to the vehicle body coordinate system.

The pose of the autonomous mobile device body relative to the reference lane line (its center line) is:

$$( {x}_{b} , {y}_{b} , {β}_{b} ) = ( {t}_{x} - {x}_{b} cos ( α - {β}_{b} ) + {y}_{b} sin {( α - {β}_{b} )}_{} ,$$

$$- {x}_{b} sin ( α - {β}_{b} ) - {y}_{b} cos ( α - {β}_{b} ) , α - {β}_{b} )$$

At S1100, an alarm message to prompt that the autonomous mobile device deviates from lane is sent, when the pose of the autonomous mobile device relative to the reference lane line meets an alarm condition.

If the abscissa in the pose of the autonomous mobile device relative to the reference lane line is in the positive direction of the lateral axis of the lane line coordinate system and the angle in the pose is greater than a preset angle (e.g., 90 degrees), it is determined that the pose indicates that the autonomous mobile device is approaching the reference lane line. Alternatively, if the abscissa in the pose is in the negative direction of the lateral axis of the lane line coordinate system and the angle in the pose is less than the preset angle (e.g., 90 degrees), it is determined that the pose indicates that the autonomous mobile device is approaching the reference lane line. When the pose indicates that the autonomous mobile device is approaching the reference lane line and the distance between the autonomous mobile device and the reference lane line is less than a preset minimum distance (which is set according to the actual operating scenario, such as 5 cm or 10 cm), the pose of the autonomous mobile device relative to the reference lane line meets the alarm condition, and an alarm message to prompt that the autonomous mobile device deviates from lane is issued at this time.

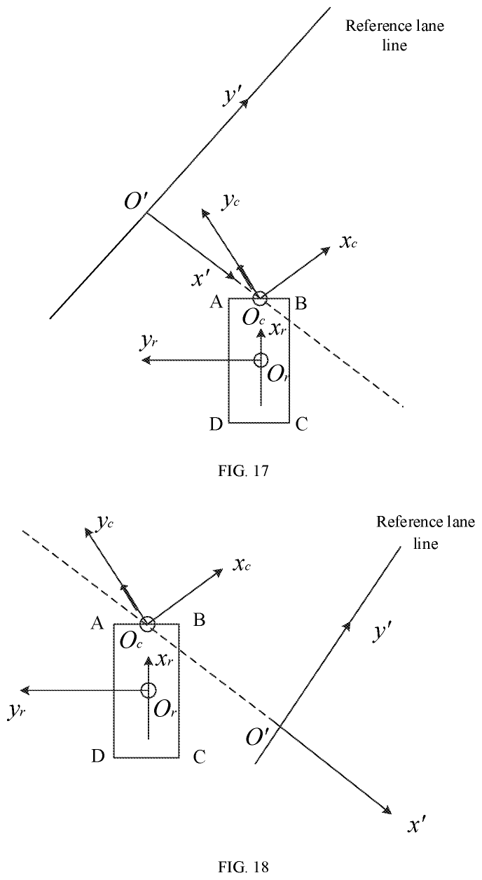

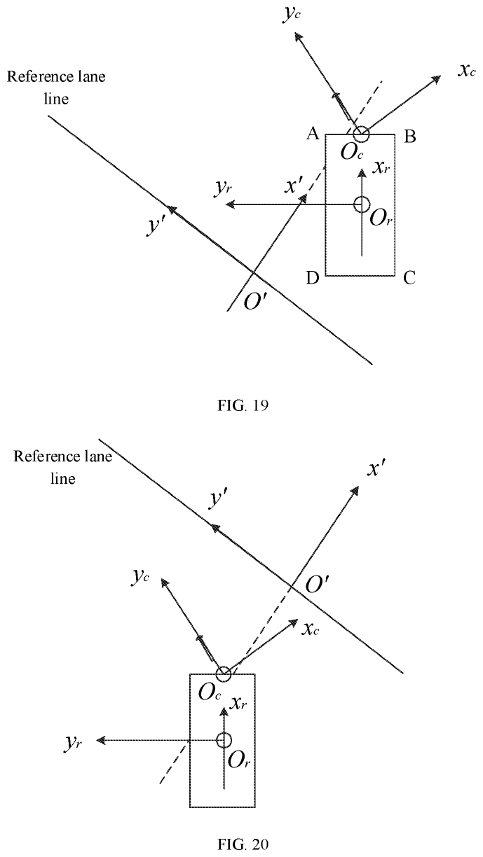

Exemplary, referring to FIG. 17 to FIG. 20, in FIG. 17 to FIG. 20, the coordinate system x′-O′-y′ is the lane line coordinate system, the coordinate system x_{c}-O_{c}-y_{c} is the camera coordinate system, the coordinate system xᵣ-Oᵣ-yᵣ is the vehicle body coordinate system, and the rectangle ABCD represents the autonomous mobile device. The lane keeping includes four scenarios shown in FIG. 17 to FIG. 20 respectively. In the scenarios illustrated in FIG. 17 and FIG. 20, the autonomous mobile device is approaching the reference lane line, and a lane departure warning is sent when |x_{b}| is less than the preset minimum distance.

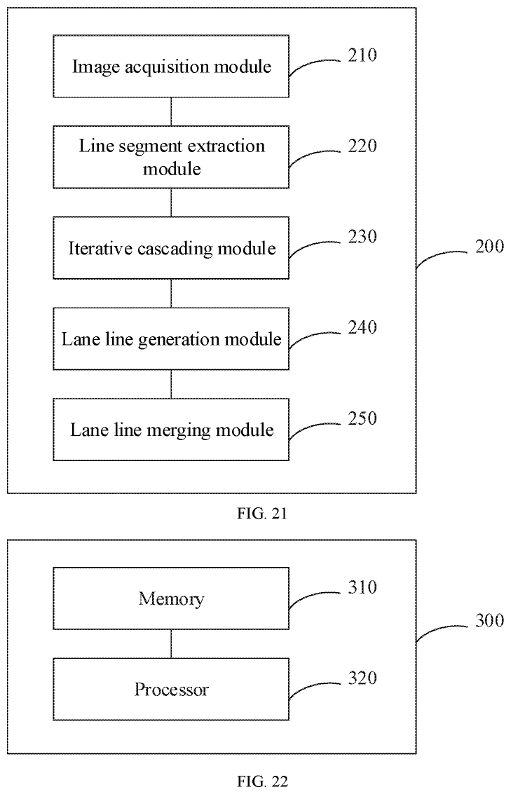

Referring to FIG. 21, a structural block diagram of a lane line detection apparatus provided in the embodiments of the present disclosure is shown. The lane line detection apparatus 200 may be applied to/implemented in the autonomous mobile device. The lane line detection apparatus 200 includes an image acquisition module 210, a line segment extraction module 220, an iterative cascading module 230, a lane line generation module 240, and a lane line merging module 250.

The image acquisition module 210 is configured to acquire an original image captured by a camera of the autonomous mobile device, and calculate the ab-channel-based gradient image according to the original image. For the specific working process of the image acquisition module 210, reference may be made to step S110 mentioned above.

The line segment extraction module 220 is configured to extract line segments located on edges of lane lines from the ab-channel-based gradient image, to obtain multiple original line segments. For the specific working process of the line segment extraction module 220, reference may be made to step S120 mentioned above.

The iterative cascading module 230 is configured to cascade, in an iterative manner, collinear line segments among the multiple original line segments, to obtain multiple cascaded line segments. For the specific working process of the iterative cascading module 230, reference may be made to step S130 mentioned above.

The lane line generation module 240 is configured to generate multiple candidate lane lines from the multiple cascaded line segments. For the specific working process of the lane line generation module 240, reference may be made to step S140 mentioned above.

The lane line merging module 250 is configured to merge collinear candidate lane lines of the multiple candidate lane lines, to obtain lane lines in the original image. For the specific working process of the lane line merging module 250, reference may be made to step S150 mentioned above.

In some embodiments, the lane line detection apparatus 200 further includes a lane line tracking module configured to execute steps S160 to S180 mentioned above. For the specific working process of the lane line tracking module, reference may be made to steps S160 to S180 mentioned above.

In some embodiments, the lane line detection apparatus 200 further includes a lane-keeping monitoring module configured to execute steps S190 and S1100 mentioned above. For the specific working process of the lane-keeping monitoring module, reference may be made to steps S190 and S1100 above.

Those skilled in the art can clearly understand that the lane line detection apparatus 200 provided in the embodiments of the present disclosure can implement the lane line detection method(s) provided in the embodiments of the present disclosure. For the specific working processes of the above apparatuses and modules, reference may be made to the corresponding processes in the method embodiments of the present disclosure, which will not be repeated here.

In the embodiments provided in the present disclosure, the coupling, direct coupling, or communication connection between the displayed or discussed modules may be indirect coupling or communication connection through some interfaces, apparatuses, or modules, and may be electrical, mechanical, or in other forms, which are not specifically limited in the embodiments of the present disclosure.

In addition, the individual functional modules in the embodiments of the present disclosure may be integrated into one processing module, or each module may exist alone physically, or two or more modules may be integrated into one module. The above integrated module may be implemented in the form of hardware or software functional modules.

Referring to FIG. 22, a structural block diagram of an autonomous mobile device provided in the embodiments of the present disclosure is illustrated. The autonomous mobile device 300 may include a memory 310 and a processor 320. An application program is stored in the memory 310, and the application program, when being called by the processor 320, causes the method(s) provided in the embodiments of the present disclosure to be implemented.

The processor 320 may include one or more processing cores. The processor 320 connects various parts within the entire autonomous mobile device 300 through various interfaces and lines, and is configured to run or execute instructions, programs, code sets, or instruction sets stored in the memory 310, and call and run or execute data stored in the memory 310 to perform various functions of the autonomous mobile device 300 and process data. The processor 320 may be implemented by at least one hardware form of Digital Signal Processor (DSP for short), Field-Programmable Gate Array (FPGA for short), and Programmable Logic Array (PLA for short). The processor 320 may integrate one or a combination of a Central Processing Unit (CPU for short), a Graphics Processing Unit (GPU for short), and a modem. The CPU mainly processes the operating system, user interfaces, application programs, etc. The GPU is responsible for rendering and drawing display content. The modem is configured to process wireless communication. It is understandable that the above modem may not be integrated into the processor 320 and may be implemented by a separate communication chip.

The memory 310 may include a Random Access Memory (RAM for short) and may also include a Read-Only Memory (ROM for short). The memory 310 may be configured to store instructions, programs, codes, code sets, or instruction sets. The memory 310 may include a program storage area and a data storage area. The program storage area may store instructions for implementing the operating system, instructions for implementing at least one function, instructions for implementing the above various method embodiments, etc. The data storage area may store data created by the autonomous mobile device 300 during use, etc.

The embodiments of the present disclosure further provide a computer-readable storage medium on which program codes are stored. The program codes, when being called by a processor, cause the method(s) provided in the embodiments of the present disclosure to be implemented. The computer-readable storage medium may be an electronic storage such as flash memory, Electrically-Erasable Programmable Read-Only Memory (EEPROM for short), Erasable Programmable Read-Only Memory (EPROM for short), hard disk, or ROM.

In some embodiments, the computer-readable storage medium may include a Non-Transitory Computer-Readable Storage Medium (Non-TCRSM for short). The computer-readable storage medium has a storage space for program codes that may execute any steps in the above methods. The program codes may be read from or written into one or more computer program products. The program codes may be compressed in an appropriate form.

Finally, it is notable that the above embodiments are only used to illustrate the technical solutions of the present disclosure, rather than limiting it. Although the present disclosure has been described in detail with reference to the foregoing embodiments, those ordinary skilled in the art should understand that they can still modify the technical solutions described in the foregoing embodiments or make equivalent substitutions for some of the technical features, and these modifications or substitutions do not cause the essence of the corresponding technical solutions to deviate from the spirit and scope of the technical solutions of the embodiments of the present disclosure.

What is claimed is:

1. A lane line detection method, comprising:
acquiring an original image captured by a camera of an autonomous mobile device, and calculating an ab-channel-based gradient image according to the original image;
extracting, from the ab-channel-based gradient image, line segments located on edges of lane lines, as multiple original line segments;
cascading, in an iterative manner, collinear line segments among the multiple original line segments, and obtaining multiple cascaded line segments through the cascading;
generating multiple candidate lane lines from the multiple cascaded line segments; and
obtaining lane lines in the original image by merging collinear candidate lane lines of the multiple candidate lane lines.

2. The method as claimed in claim 1, wherein the cascading, in an iterative manner, collinear line segments among the multiple original line segments, and obtaining multiple cascaded line segments through the cascading, comprises:
converting the multiple original line segments to a ground coordinate system, and calculating an included angle between each of the multiple original line segments and a lateral axis of the ground coordinate system, as a direction angle of each of the multiple original line segments;
obtaining a sequence of original line segments, by sorting the multiple original line segments according to the direction angles of the multiple original line segments; and
obtaining the multiple cascaded line segments, by sequentially cascading, according to the sequence of original line segments and in the iterative manner, collinear line segments among the multiple original line segments.

3. The method as claimed in claim 2, wherein before the obtaining the multiple cascaded line segments by sequentially cascading, according to the sequence of original line segments and in the iterative manner, collinear line segments among the multiple original line segments, the method further comprises:
determining a preferred lane line direction, according to the direction angles of the multiple original line segments; and
selecting, from the multiple original line segments, original line segments having the preferred lane line direction or original line segments with a length greater than a length threshold, as preferred line segments, and setting a preferred flag of each of the preferred line segments to true; and
the obtaining the multiple cascaded line segments by sequentially cascading, according to the sequence of original line segments and in the iterative manner, collinear line segments among the multiple original line segments, comprises:
obtaining the multiple cascaded line segments, by sequentially cascading, according to the sequence of original line segments, collinear line segments among the multiple original line segments, in an iterative manner in which each iteration involves cascading of two line segments, wherein the two line segments comprise a first line segment and a second line segment, the first line segment has a preferred flag of true and the first line segment has not been merged.

4. The method as claimed in claim 3, wherein the obtaining the multiple cascaded line segments by sequentially cascading, according to the sequence of original line segments and in the iterative manner, collinear line segments among the multiple original line segments, comprises:
in a first iteration, obtaining a first preferred line segment from the sequence of original line segments as a first line segment involved in this iteration;
searching for a second line segment that meets an original line segment cascading condition;
in response to searching out the second line segment that meet the original line segment cascading condition, merging the first line segment and the second line segment according to the number of original line segments comprised in each of the first line segment and the second line segment, and obtaining, through the merging, a cascaded line segment of this iteration; setting a preferred flag of the cascaded line segment obtained in this iteration to true, using the cascaded line segment obtained in this iteration as a first line segment of a next iteration, and returning to the operation of searching for a second line segment that meets the original line segment cascading condition, until an iteration end condition is met, thereby obtaining the multiple cascaded line segments;
in response to searching out no second line segment that meet the original line segment cascading condition, setting the preferred flag of the first line segment to false, determining a first line segment involved in a next iteration from other preferred line segments according to the sequence of original line segments, and returning to the operation of searching for a second line segment that meets the original line segment cascading condition, until the iteration end condition is met, thereby obtaining the multiple cascaded line segments.

5. The method as claimed in claim 4, wherein the merging the first line segment and the second line segment according to the number of original line segments comprised in each of the first line segment and the second line segment, and obtaining, through the merging, a cascaded line segment of this iteration, comprises:
in response to the number of original line segments comprised in the first line segment being greater than or equal to the number of original line segments comprised in the second line segment, obtaining the cascaded line segment of this iteration, by merging the second line segment with the first line segment with the second line segment located after the first line segment;
in response to the number of original line segments comprised in the first line segment being less than the number of original line segments comprised in the second line segment, obtaining the cascaded line segment of this iteration, by merging the first line segment with the second line segment with the first line segment located after the second line segment.

6. The method as claimed in claim 4, wherein the searching for a second line segment that meets the original line segment cascading condition, comprises:
in response to a difference between the direction angle of a searched second line segment and the direction angle of the first line segment being less than a preset angle, a lateral distance between the searched second line segment and the first line segment being less than a preset lateral distance error, and a front-rear distance between the searched second line segment and the first line segment along a line segment direction being less than a preset gap, determining the searched second line segment as the second line segment meeting the original line segment cascading condition.

7. The method as claimed in claim 1, wherein the generating multiple candidate lane lines from the multiple cascaded line segments comprises:
acquiring a preset lane line width specification and a preset lane line color specification;
selecting, according to the preset lane line width specification, multiple line segment pairs from the multiple cascaded line segments, each line segment pair comprising two cascaded line segments;
performing a first color verification on the multiple line segment pairs, according to the preset lane line color specification; and
generating the multiple candidate lane lines according to line segment pairs passing the first color verification, wherein each line segment pair passing the first color verification corresponds to one candidate lane line.

8. The method as claimed in claim 7, wherein the selecting, according to the preset lane line width specification, multiple line segment pairs from the multiple cascaded line segments, comprises:
calculating an included angle between each of the multiple cascaded line segments and a lateral axis of a ground coordinate system, as a direction angle of each of the multiple cascaded line segments;
obtaining a sequence of cascaded line segments, by sorting the multiple cascaded line segments according to the direction angles of the multiple cascaded line segments; and
sequentially selecting, according to the sequence of cascaded line segments, multiple line segment pairs from the multiple cascaded line segments, wherein a difference between the direction angles of two line segments comprised in each line segment pair is less than a preset angle and a lateral distance between the two line segments meets the preset lane line width specification; and
wherein the performing a first color verification on the multiple line segment pairs according to the preset lane line color specification, comprises:
for each line segment pair in the multiple line segment pairs, acquiring color intensity distributions of two original line segments comprised in this line segment pair in a color channel and b color channel; and
based on a determination that the color intensity distributions meet the preset lane line color specification, determining that this line segment pair passes the first color verification.

9. The method as claimed in claim 1, wherein the obtaining lane lines in the original image by merging collinear candidate lane lines of the multiple candidate lane lines, comprises:
obtaining multiple long lane lines, by merging collinear candidate lane lines of the multiple candidate lane lines, wherein a length of each of the multiple long lane lines is longer than a length threshold; and
performing a second color verification on the multiple long lane lines, and taking a long lane line passing the second color verification as the lane line in the original image.

10. The method as claimed in claim 9, wherein the obtaining multiple long lane lines by merging collinear candidate lane lines of the multiple candidate lane lines, comprises:
calculating an included angle between each of the multiple candidate lane lines and a lateral axis of a ground coordinate system, as a direction angle of each of the multiple candidate lane lines;
obtaining a sequence of candidate lane lines, by sorting the multiple candidate lane lines according to the direction angles of the multiple candidate lane lines; and
obtaining the multiple long lane lines, by sequentially merging, according to the sequence of candidate lane lines, collinear candidate lane lines of the multiple candidate lane lines; and
wherein the performing a second color verification on the multiple long lane lines, and taking a long lane line passing the second color verification as the lane line in the original image, comprises:
for each long lane line of the multiple long lane lines, finding at least one pair of original line segments from this long lane line;
acquiring color intensity distributions of an area between two line segments comprised in the at least one pair of original line segments in a color channel and b color channel; and
based on a determination that the color intensity distributions meet a preset lane line color specification, determining that this current long lane line passes the second color verification.

11. The method as claimed in claim 1, wherein the acquiring an original image captured by a camera of an autonomous mobile device and calculating an ab-channel-based gradient image according to the original image, comprises:
acquiring the original image captured by the camera of the autonomous mobile device;
converting the original image into a Lab image; and
obtaining the ab-channel-based gradient image, by constructing, with a DiZenzo operator utilizing GPU acceleration, a gradient image based on a color channel and b color channel of the Lab image;
wherein when the autonomous mobile device is located on ground, a distance between the camera and the ground is less than a specified height, and an included angle between an orientation of the camera and the ground is less than a specified angle.

12. The method as claimed in claim 1, wherein after obtaining the lane lines in the original image by merging the collinear candidate lane lines of the multiple candidate lane lines, the method further comprises:
obtaining lane lines in consecutive multiple frames of original images;
determining a reference lane line according to the lane lines in the consecutive multiple frames of original images; and
performing lane line tracking according to the reference lane line.

13. The method as claimed in claim 12, wherein the determining a reference lane line according to the lane lines in the consecutive multiple frames of original images comprises:
determining, from the lane lines in the consecutive multiple frames of original images, a lane line whose length is greater than a preset length, which is closest to the autonomous mobile device, and which is detected in consecutive multiple ab-channel-based gradient images, as the reference lane line.

14. The method as claimed in claim 12, wherein the performing lane line tracking according to the reference lane line comprises:
during movement of the autonomous mobile device, acquiring lane lines in a current frame of original image;
in response to there being a lane line matching the reference lane line among the lane lines in the current frame of original image, updating the reference lane line by taking the lane line matching the reference lane line as a new reference lane line;
in response to there being no lane line matching the reference lane line among the lane lines in the current frame of original image, not updating the reference lane line and keeping the reference lane line unchanged.

15. The method as claimed in claim 14, wherein after acquiring the lane lines in the current frame of original image, the method further comprises:
for each lane line of the lane lines in the current original image, based on a determination that a distance between this lane line and the reference lane line meets a position requirement, a width of this lane line is the same as a width of the reference lane line, and color intensity distributions of pixels in this lane line in a color channel and b color channel meet a preset lane line color specification, determining that this lane line matches the reference lane line.

16. The method as claimed in claim 12, wherein after determining the reference lane line according to the lane lines in the consecutive multiple frames of original images, the method further comprises:
calculating a pose of the autonomous mobile device relative to the reference lane line; and
based on a determination that the pose meets an alarm condition, sending an alarm message to prompt that the autonomous mobile device deviates from lane.

17. The method as claimed in claim 16, wherein the calculating a pose of the autonomous mobile device relative to the reference lane line comprises:
constructing a lane line coordinate system according to the reference lane line;
acquiring a camera coordinate system and a vehicle body coordinate system of the autonomous mobile device;
calculating a transformation matrix between the vehicle body coordinate system and the lane line coordinate system, according to the lane line coordinate system, the vehicle body coordinate system and the camera coordinate system; and
calculating, according to the transformation matrix, the pose of the autonomous mobile device relative to the reference lane line.

18. The method as claimed in claim 16, wherein sending, based on the determination that the pose meets the alarm condition, the alarm message to prompt that the autonomous mobile device deviates from lane, comprises:
in response to the pose indicating that the autonomous mobile device is approaching the reference lane line and a distance between the autonomous mobile device and the reference lane line is less than a preset minimum distance, sending the alarm message to prompt that the autonomous mobile device deviates from lane; and
wherein before sending, based on the determination that the pose meets the alarm condition, the alarm message to prompt that the autonomous mobile device deviates from lane, the method further comprises:
in response to an abscissa in the pose being located in a positive direction of a lateral axis of the lane line coordinate system, and an angle in the pose being greater than a preset angle, determining that the pose indicates that the autonomous mobile device is approaching the reference lane line; or
in response to the abscissa in the pose being located in a negative direction of the lateral axis of the lane line coordinate system, and the angle in the pose being less than the preset angle, determining that the pose indicates that the autonomous mobile device is approaching the reference lane line.

19. An autonomous mobile device, comprising:
a camera, a memory and a processor, wherein the memory stores an application program which, when being called by the processor, causes the processor to:
acquire an original image captured by the camera, and calculate an ab-channel-based gradient image according to the original image;
extract, from the ab-channel-based gradient image, line segments located on edges of lane lines, as multiple original line segments;
cascade, in an iterative manner, collinear line segments among the multiple original line segments, and obtain multiple cascaded line segments through the cascading;
generate multiple candidate lane lines from the multiple cascaded line segments; and
obtain lane lines in the original image by merging collinear candidate lane lines of the multiple candidate lane lines.

20. A non-transitory computer-readable storage medium storing program codes thereon, wherein the program codes, when being called by a processor, cause the processor to:
acquire an original image captured by a camera of an autonomous mobile device, and calculate an ab-channel-based gradient image according to the original image;
extract, from the ab-channel-based gradient image, line segments located on edges of lane lines, as multiple original line segments;
cascade, in an iterative manner, collinear line segments among the multiple original line segments, and obtain multiple cascaded line segments through the cascading;
generate multiple candidate lane lines from the multiple cascaded line segments; and
obtain lane lines in the original image by merging collinear candidate lane lines of the multiple candidate lane lines.
